(19) United States
(12) Patent Application Publication
(10) Pub. No.: US 2003/0020409 A1
(43) Pub. Date: Jan. 30, 2003

(54) Low mercury metal halide lamp

(76) Inventors: Timothy Lee Kelly, Boston, MA (US); Martin Edward Muzeroll, Merrimack, NH (US); Stephan Lambrechts, Beverly, MA (US); Jakob Maya, Brookline, MA (US)

Correspondence Address: Owen J. Meegan, 65 Dearborn Street, Salem, MA, 01970, US

(21) Appl. No.: 10/165,898

(22) Filed: Jun. 10, 2002

Related U.S. Application Data
(63) Continuation-in-part of application No. 07/391,194, filed on Aug. 9, 1989, now Pat. No. 5,039,932.

(51) Int. Cl. H01J 17/20

(52) U.S. Cl. 313/640

(57) ABSTRACT

A metal halide lamp of about 90% reduced mercury content with performance (efficacy, CCT, CRI) equivalent to a standard commercial metal halide lamp. The lamp comprises an arc shaped tube disposed within an outer jacket and including a fill of a metal halide and not more then about 2.7 mg mercury/cc of arc tube. The arc tube has an inner diameter to arc gap ratio of between about 0.10 and 0.16 and the wall loading of the reduced mercury lamp being equivalent to a standard metal halide lamp of about 20 W/cm². The metal halide comprises Na and/or Sc iodides of various ratios depending on the color temperature desired, and a rare gas such as Xe, Kr, Ar in pressures of 10-300 torr dependent on the power loading and desired operating voltage of the lamp.

### CROSS-REFERENCE TO RELATED APPLICATIONS

This application is a Continuation-In-Part of our copending application, Ser. No. 07/391,194, filed Sep. 7, 1999.

### BACKGROUND OF THE INVENTION

The present invention relates to a quartz metal halide discharge lamp containing a significantly reduced amount of mercury compared to a standard quartz commercial product. A lesser amount of mercury is desirable since mercury is potentially toxic to humans and its inclusion in a lamp may, in certain jurisdictions, causes the lamp to be considered as hazardous waste, necessitating expensive and time-consuming disposal. The complete removal of mercury from a metal halide design has yet to be demonstrated as feasible because mercury has several important functions in a metal halide lamp which have not been successfully substituted without performance degradation. Mercury is especially important in providing high efficacy in a metal halide lamp by decreasing current, serving as a buffer gas to insulate the arc from heat losses, and reacting with free iodine atoms to prevent the formation of I₂ molecules which absorb visible radiation. The formation of I₂ molecules must also be prevented to enable easy ignition of the lamp with customary circuitry. The arc tube of the herein disclosed low mercury content lamp has a volume of 0.6 to 1.0 cm³ with 0.4 to 2.0 mg of mercury. The disclosed low-mercury lamp is designed to perform these functions with a minimal amount of mercury while maintaining performance equivalent to a standard arc tube having a volume of 1.0 to 3.5 cm³ with 8 to 25 mg of mercury.

### SUMMARY OF THE PRIOR ART

It is known how to increase lamp voltage in metal halide lamps from U.S. Pat. Nos. 3,840,767 and 3,876, 895. It is also known how to increase lamp operating pressure from U.S. Pat. Nos. 3,840,767 and 3,876,895. Decreasing heat losses from the arc by using a thermal buffer is disclosed in U.S. Pat Nos. 3,840,767 and 3,876,895.

U.S. Pat. No. 4,360,756 discloses reacting excess I⁻ ions to prevent the formation of I_{2.} Excess I₂ leads to decreased efficacy and difficult starting. U.S. Pat. No. 3,876,895 discloses closes a standard sized arc tube of 8 mm inside diameter and an arc tube gap of 10 cm with an internal volume of 6 cm³ and containing 0.6 mg of mercury.

### SUMMARY OF THE INVENTION

According to the present invention, we have found the mercury content of a lamp can be reduced by over 85% when compared to a standard quartz metal halide lamp of equal wattage. Such lamps can have performance (efficacy CCT, CRI, D_{UV}) equivalent to a standard quartz metal halide lamp of equal wattage. The lamps of the present invention can be fabricated with conventional quartz lamp production equipment to produce lamps which have brighter, whiter light immediately upon starting than attained with standard metal halide lamps.

In an effort to create a metal halide lamp with little or no mercury, a study was undertaken with the goal of producing a more environmentally friendly metal halide lamp with efficacy, color temperature, color rendering and a life comparable to a standard metal halide lamp. The utilization of current process technology for low cost and manufacturing were also considered as important. Early theoretical and experimental work identified key problems faced when reducing mercury dosage in metal halide lamps. These are identified in Table 1. Lower efficacy results from at least three effects. A decrease in lamp voltage causes an increase in current which results in increased resistive losses in the ballast and electrodes. Less Hg pressure during operation provides less thermal buffering of the arc which increases heat loss from the arc tube. If Hg is excessively reduced, molecular iodine (I₂) forms and absorbs visible radiation and reduces efficacy. I₂ also makes starting difficult with conventional circuitry and increases restrike time.

TABLE 1
Effects of Mercury in Low-Mercury
vs.
Standard Metal Halide Lamp

| Critical Hg Influ- | Standard Metal | Low-Mercury Metal |
|---|---|---|
| enced items | Halide | Halide |
| Voltage - must be | Mercury raises | Voltage is in- |
| controlled to | operating voltage | creased by length- |
| achieve proper power | to required level. | ening arc tube. |
| level and operation | | The arc tube is |
| on conventional | | made narrower to |
| ballasting circuitry | | maintain appropriate |
| | | wall loading. |
| Buffer Gas - insulates | Mercury acts to | Extra rare gas |
| arc to reduce | insulate the arc | (preferably xenon) |
| heat loss and allow | from heat loss. | is added for buffering |
| for higher arc | | arc and providing |
| temperature. | | optimal pressure. |
| Control of molecular | Hg reacts with any | A relatively small |
| iodine (I₂). | free iodine to | amount of mercury |
| When metal iodides | form HgI₂ which | is sufficient to |
| dissociate during | transmits visible | eliminate I₂ as in |
| normal operation, | light. I₂ interference | the standard lamp. |
| free iodine is produced. | with starting | Because of the |
| If I₂ is produced | is avoided. | long narrow geometry |
| duced it absorbs | | the low-mercury |
| visible light and | | lamp has a |
| makes starting | | smaller volume |
| difficult. | | which requires |
| | | even less Hg. |

A metal halide chemistry of sodium iodide and scandium iodide was chosen for experimentation and the arc tubes were fabricated from quartz. In order to compensate for decreased Hg, the following approaches were taken. The arc gap was increased to raise lamp voltage and reduce current. The diameter of the arc tube was reduced to maintain proper wall loading and reduce volume. Xe was substituted for Ar as a starting gas inside the arc tube and the pressure was raised to 200 torr to provide more thermal buffering. Chemistry changes were made to identify an optimal Na/Sc ratio and to experiment with the use of Zn and ZnI₂ to increase voltage, act as a buffer gas and scavenge free iodine.

Two different arc tube sizes were developed for testing low mercury metal halide arc tubes based on the wall loading calculations shown in Table 2. These are shown in FIGS. 1 and 2. The “400 W” size with 7×10 mm tubing with a volume of 4.0 cm³ was tried initially but abandoned in favor of a 5×7 mm tube size with a volume of 0.8 cm³ for a lamp in the 110 W-150 W range. This was done to reduce arc segregation and temperature variation, and for ease of processing and testing. Also, the 95 V standard voltage of a 150 W lamp was an easier target than the 135 V standard voltage of a 400 W lamp.

TABLE 2
Mercury Free Metal Halide Wall Loading

| | | | | Sur- | | | |
|---|---|---|---|---|---|---|---|
| | | Arc | | face | | | |
| | | Length | ID | Area | | | |
| | Watts | (mm) | (mm) | cm² | W/cm² | V | A |
| Std. | 400 | 36 | 18 | 30.5 | 13.1 | 135.0 | 3.25 |
| 400 W | | | | | | | |
| (˜56 mg | | | | | | | |
| Hg | | | | | | | |
| 15 × 17 mm | 200 | 63 | 15 | 36.7 | 5.4 | 45.0 | 4.4 |
| no Hg | | | | | | | |
| 7 × 10 mm | 300 | 100 | 7 | 23.5 | 12.8 | 70.7 | 4.6 |
| no Hg | | | | | | | |
| 7 × 10 mm | 400 | 100 | 7 | 23.5 | 17.0 | 72.4 | 5.8 |
| no Hg | | | | | | | |
| 5 × 7 mm | 110 | 37 | 5 | 6.6 | 16.7 | 51.5 | 2.3 |
| no Hg | | | | | | | |
| 5 × 7 mm | 150 | 37 | 5 | 6.6 | 22.7 | 52.0 | 3.2 |
| no Hg | | | | | | | |
| Std. | 150 | 13.5 | | | 19-22 | 95.0 | 1.8 |
| 150 W | | | | | | | |
| (˜16 mg | | | | | | | |
| Hg) | | | | | | | |

### BRIEF DESCRIPTION OF THE DRAWINGS

FIG. 1 is a side elevational view of a high pressure metal halide arc tube disposed in a harness and fitted within an envelope.

FIGS. 2a and 2b are side views of arc tubes of different sizes and 2c is a segmented view of a particular end seal of the arc tube.

FIG. 3 is a curve plotting voltage vs. mercury dosage.

FIG. 4 are curves plotting mercury content in various lamps with different chemistries.

### PREFERRED EMBODIMENTS OF THE INVENTION

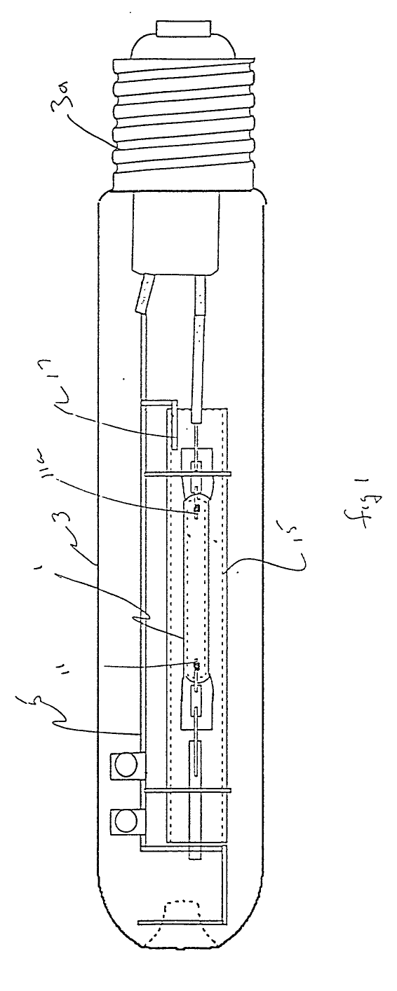

Referring to FIG. 1, we have found the geometry of the low-mercury metal halide design is critical to achieving performance equivalent to a standard metal halide lamp. An embodiment of a lamp is shown in FIG. 1. The lamp includes a 46 mm Nonex jacket 3 which is connected to a conventional base 3a. A 5×7 mm arc tube 1 is disposed within the jacket 3. Electrodes 11 and 11a are disposed within the arc tube 1 and are attached to molybdenum foil sections. A lead-in wire 9 is attached to the foil sections. One side of a power supply is connected to electrode 11 by means of a harness 5 which also holds the arc tube 1 in place within the jacket 3. The other side of the power supply is connected to electrode 11a by means of connector 17. A quartz shroud 15, 15×17 mm, is fitted around the arc tube 1 to increase the heat within the arc tube 1.

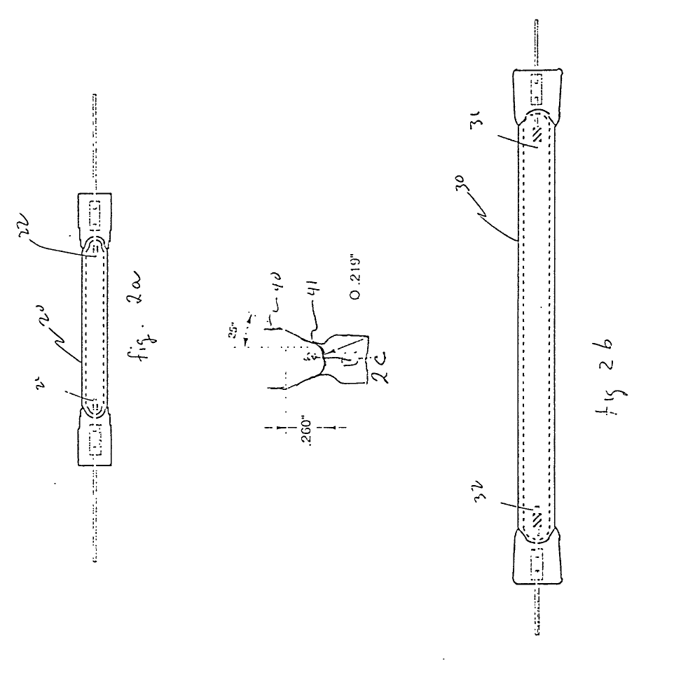

Shown in FIG. 2a is a view of a low-mercury arc tube to be operated in a 110-150 W range. FIG. 2a shows a quartz arc tube 20 with a 40 mm gap and a diameter of about 5 mm and a 37.5 mm gap between electrodes 21 and 22 and a volume of 0.8 to 1.6 cm³. In FIG. 2b, the gap between electrodes 31 and 32 is 100 mm for a 400 W version having an inner diameter of about 7 mm and a volume of 4.0 to 8.4 cm³. Particularly important is the ratio of the inner tube diameter to arc gap. A ratio between about 0.10 and 0.16 and especially about 0.13 provides for the required voltage of 95 V in a 150 W lamp with only 2 mg of mercury vs. 16 mg used in a standard metal halide 150 W lamp.

In lamps according to the present invention, we have found that the mercury can be reduced to less than about 2.7 mg of Hg/cm³ of the arc tube.

Table 3 provides a performance comparison between low-mercury and standard lamps. In a horizontal operating position with electronic ballast, it can be seen that the low-mercury lamp is equivalent to vertical burning quartz lamps.

TABLE 3
Performance Comparison-Low-Hg vs. Standard Metal Halide Lamp

| | | | | |
|---|---|---|---|---|
| Lamp | LPW | CCT | CRI | W/cm² |

Vertical Base Up Operation

| | | | | | |
|---|---|---|---|---|---|
| Commercial | Venture 150 W | 90 | 3984 | 72 | 19 |
| Lamps 100 hr | | | | | |
| | GE 150 W | 80 | 4017 | 78 | 21.6 |
| | OSI 3K 100 W | 85 | 3126 | 84 | 21.0 |
| | (designer | | | | |
| | series) | | | | |
| | OSI 4K 100 W | 80 | 4000 | 80 | |
| | (std. Metalarc) | | | | |
| Test Lamps: | Low Mercury | 81 | 3247 | 55 | 22.7 |
| 100 hr. | (2.0 mg Hg) 150 W | | | | |
| Test Lamps: | Low Mercury | 60 | 4126 | 57 | 15.2 |
| 100 hr | (2.0 mg Hg) 100 W | | | | |

Horizontal Operation

| | | | | | |
|---|---|---|---|---|---|
| Commercial | GE 150 W | <vert. | | | |
| Lamps 100 hr | | | | | |
| | OSI 4K 100 W | <vert. | | | |
| | (std. Metalarc) | | | | |
| Test Lamps; | Low Mercury | 89 | 4081 | 71 | 22.7 |
| 100 hr. | (2.0 mg Hg) 150 W | | | | |
| Test Lamps; | Low Mercury | 72 | 4598 | 69 | 15.2 |
| 100 hr. | (2.0 mg Hg) 100 W | | | | |

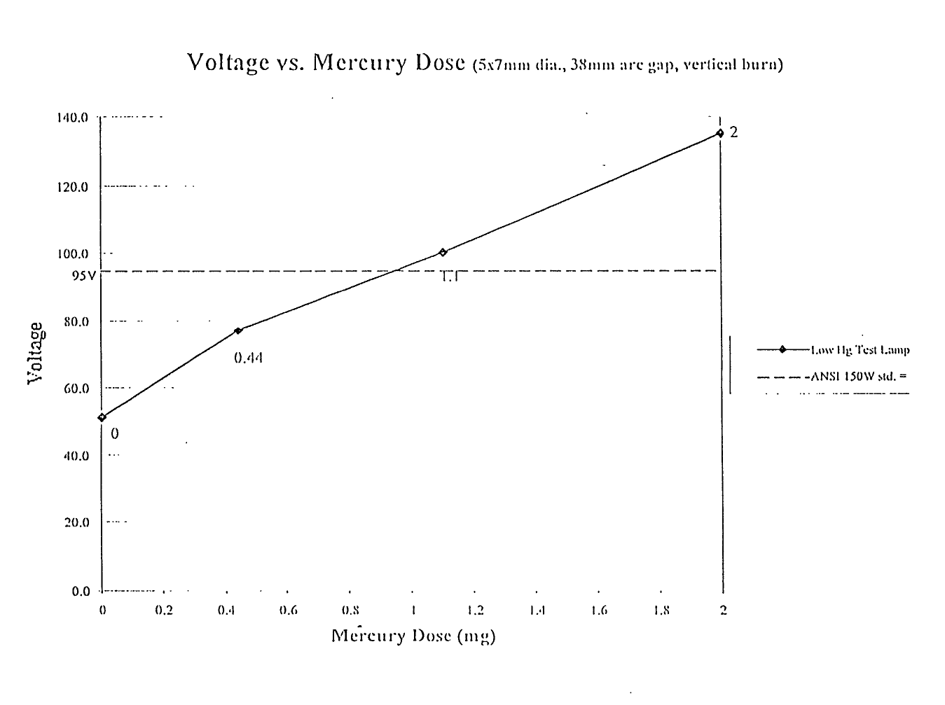

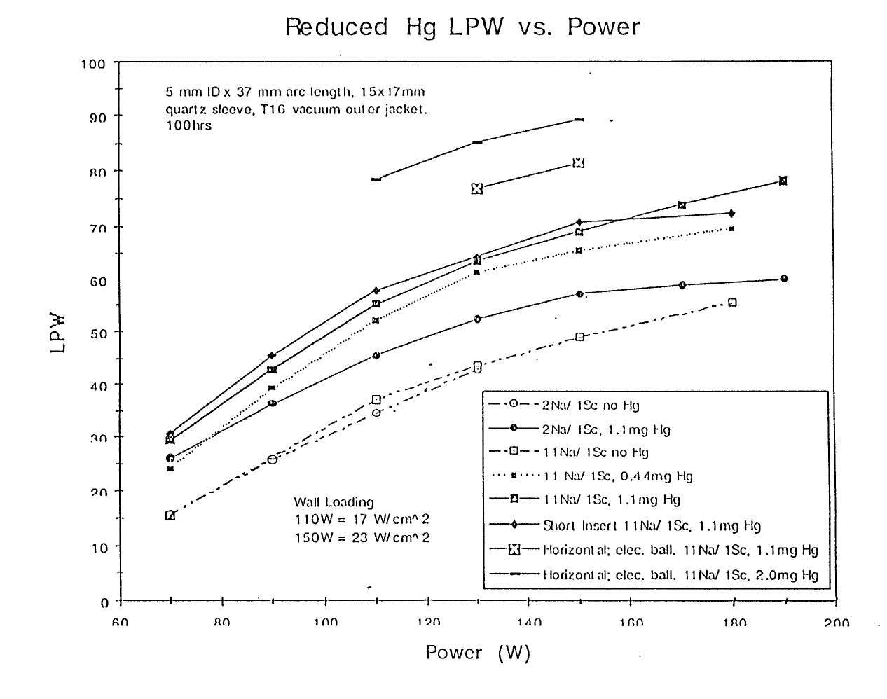

In both 7×10 mm and 5×7 mm sizes, lamps were made to test the effects of mercury dose and Na/Sc molar ratio on electrical and photometric characteristics. Some lamps with a shorter electrode insertion length were also measured. For accurate mercury dosing of quantities ≦2.0 mg, mercuric iodide spheres were used. In these lamps, scandium chips were substituted for scandium iodide, as needed, to maintain consistent tent metal/iodine ratios. Unless noted, data is from lamps burned vertically with a 60 Hz linear reactor ballast. Optimal performance was achieved later in the project with lamps burned horizontally with a 142 Hz electronic square wave ballast last. In cases where this data is presented, special notation is included to indicate horizontal burning position and/or electronic ballast. Although data from 7×10 mm arc tube samples was valuable in initial testing, data from the 5×7 mm lamps is more comprehensive and thus the only data presented. All of the lamps have an arc tube fill gas of 200 torr Xe, a 15×17 mm diameter quartz sleeve, and a ˜50 mm diameter vacuum outer jacket. The outer jacket is filled with either an inert gas such as nitrogen or kept under vacuum. Standard size 150 W electrodes were used. Based on availability, pure tungsten electrodes were used instead of thoriated tungsten. The effect of using pure tungsten electrodes is not totally clear but does not appear significant for short term testing. FIG. 3 shows the effect of mercury dose on lamp voltage. FIG. 4 shows the efficacy of various experimental lamps with different chemistries and mercury doses.

We have found that to obtain the above-described favorable performance, the end wall 41 of the arc tube 40 had to be ellipsoidally-shaped with the electrode 42 disposed within the well of the seal, as shown in FIG. 2c. The ellipsoidal shape helped raise the vapor pressure of the salts and led to increased efficacy.

Since zinc is chemically similar to mercury (both are in column IIB of the periodic table) and has a relatively high vapor pressure, testing was done to determine whether zinc could produce the following benefits in a lamp with reduced mercury content.

Metallic elements other than zinc were considered for mercury substitution but not tested. Several lamps were made to test the effects of zinc substitution for mercury, all of which were burned vertically. These lamps can be grouped into three categories.

1. Standard type 400 W lamps with 100% or 50% atomic substitution of zinc for mercury.

2. “400 W” 7×10 mm diameter, 100 mm arc gap lamps with no mercury.

3. “400 W” 7×10 mm diameter, 100 mm arc gap lamps with small amounts of zinc & mercury dosed by 50:50 wt% Zn:Hg amalgam.

The following 400 W standard type Na/Sc metal halide lamps were tested.

| Lamp | Descrip- | | | | | | | |
|---|---|---|---|---|---|---|---|---|
| ID | tion | V | A | W | Lumens | LPW | CCT | CRI |
| 1 | 400 W | 38. | 5.70 | 200 | 2140 | 11 | 4415 | 52 |
| | Std. Zn | | | | | | | |
| | for Hg, | | | | | | | |
| | 100% | | | | | | | |
| | atomic | | | | | | | |
| | substi- | | | | | | | |
| | tution | | | | | | | |
| 2 | 400 W | 95. | 4.98 | 400 | 21490 | 54 | 2621 | 33 |
| | Std. | | | | | | | |
| | 50:50 | | | | | | | |
| | atomic | | | | | | | |
| | % Zn:Hg | | | | | | | |
| 400 W | OSI MS | 133 | 3.23 | 400 | 39580 | 99 | 4278 | 66 |
| Std. | 400 W; | | | | | | | |
| | 56 mg Hg | | | | | | | |

The 100% substitution lamp (#1) was not measured at 400 W due to low voltage. The table shows that all aspects of lamp performance suffered when Zn was substituted for Hg.

Group 2. The following mercury-free “400 W” 7×10 mm, 100 mm length arc tubes were tested.

| ID | Desc. | V | A | W | Lumens | LPW | CCT | CRI |
|---|---|---|---|---|---|---|---|---|
| 3 | 2Na/1Sc; | — | — | — | — | — | — | — |
| | no Hg; | | | | | | | |
| | 1.5 mg Zn | | | | | | | |
| 4 | 2Na/1Sc; | 119.2 | 3.69 | 400 | 11823 | 30 | 2617 | 7 |
| | no Hg; | | | | | | | |
| | 1.5 mg Zn | | | | | | | |
| 5 | 12Na/1Sc | 72.4 | 5.83 | 400 | 8478 | 21 | 3610 | 59 |
| | no Hg | | | | | | | |
| 6 | 12Na/1Sc | 130.4 | 3.48 | 400 | 15606 | 39 | 5006 | 49 |
| | 1.5 mg Hg | | | | | | | |
| 7 | 12Na/1Sc | 164.4 | 2.80 | 400 | 18438 | 46 | 4632 | 41 |
| | 4.4 mg Hg | | | | | | | |

1.5 mg of Zn was chosen because it corresponds to the same molar quantity as the 4.4 mg Hg lamp (#7), which was already tested. After 19 hours of burning, lamp #3 exhibited devitrification and a large bulge in the quartz wall near the bottom electrode. It was removed from testing. Lamp #4 was measured after 100 hrs and compared with lamps of 0, 1.5, & 4.4 mg Hg.

Based on this data, Zn appears to raise the voltage and efficacy of a mercury free lamp but dramatically lowers CRI and CCT and cannot come close to matching the performance of the lamp with mercury.

Group 3. The lamps listed below are “400 W” low mercury 7×10 mm diameter are tubes, 100 mm arc gap. A 50:50 wt% (3Zn:1 Hg molar%) Zn/Hg amalgam was used to substitute for pure mercury.

| Lamp | | | | | | | | |
|---|---|---|---|---|---|---|---|---|
| ID | Desc. | V | A | W | Lumens | LPW | CCT | CRI |
| 8 | 12Na/ | 79.2 | 5.40 | 400 | 13143 | 33 | 4152 | 61 |
| | 1Sc; | | | | | | | |
| | 1 mg | | | | | | | |
| | Hg/1 mg | | | | | | | |
| | Zn | | | | | | | |
| | amalgam | | | | | | | |
| 8 | 12Na/ | 118.4 | 3.78 | 400 | 6877 | 17 | 20448 | 77 |
| | 1Sc; | | | | | | | |
| | 1 mg | | | | | | | |
| | Hg/1 mg | | | | | | | |
| | Zn | | | | | | | |
| | amalgam | | | | | | | |
| 9 | 2Na/ | 153.7 | 3.10 | 400 | 12691 | 32 | 8396 | 81 |
| | 1Sc;1 mg | | | | | | | |
| | Hg/1 mg | | | | | | | |
| | Zn | | | | | | | |
| | amalgam | | | | | | | |
| 6 | 12Na/ | 130.4 | 3.48 | 400 | 15606 | 39 | 5006 | 49 |
| | 1Sc; | | | | | | | |
| | 1.5 mg | | | | | | | |
| | Hg | | | | | | | |

The 5 hour and 100 hour photometry readings of a lamp containing 1 mg of Zn and 1 mg of Hg with 12 Na/1Sc molar ratio iodides show that sodium and scandium lines are very pronounced (as expected) at 5 hours but almost gone at 100 hours.

The zinc and mercury lines, which are stronger at 100 hours than at 5 hours, contrast this and seem to indicate that the zinc is preferentially reacting with iodine to form ZnI₂ at the expense of NaI and ScI_{3.}

The devitrification visible in the arc tube quartz also indicates that the reactions favored were as follows:

Zn+2NaI→ZnI₃+2Na

3Zn+2 ScI₃→3ZnI₂+2Sc

The free Na and Sc generated by these reactions presumably reacted with the quartz wall to cause devitrification.

In summary, adding Zn to a mercury free Na/Sc metal halide lamp was somewhat successful in raising lamp voltage and performance but performance and life were inferior compared to equivalent lamps with even small amounts of mercury. Furthermore, even small amounts of Zn showed up significantly in the spectrum as a relatively inefficient visible light emitter and imbalanced arc tube chemistry causing devitrification of the quartz wall.

During the course of the project, it became apparent that a mercury free metal halide lamp was much more difficult to develop than one with even a small amount of mercury. Part of the difficulty arises when iodine within the arc tube forms molecular I₂ instead of HgI₂. Without mercury, free iodine was visible as a purple gas inside the arc tube for at least several minutes upon lamp shutoff. A lamp was dosed with standard 11Na/1Sc zero-Hg chemistry plus 0.5 mg InI added as an intended scavenger of free iodine via the following reaction: InI+I₂)→InI₃. Upon shutoff, the lamp did not exhibit a purple color so apparently this iodine scavenging approach was successful. However, indium was quite pronounced in the spectrum and had a negative effect on color and efficacy.

It is apparent that modifications and changes may be made within the spirit and scope of the present invention, but it is our intention, however, only to be limited by the scope of the following claims.

As our invention, we claim:

1. A metal halide lamp of reduced mercury content with performance (efficacy, CCT, CRI) equivalent to a standard commercial metal halide lamp said lamp comprising:
an arc tube having electrodes at each end thereof disposed within an outer jacket, said arc tube having a volume of 0.6 to 1.0 cm³, said electrodes each being housed within ellipsoidally-shaped end walls, said arc tube including a fill of a metal halide and a significant amount but not more than about 2.7 mg mercury/cm³ of arc tube and 2 mg mercury/arc tube, said arc tube having a ratio of inner diameter to arc gap of between about 0.10 and 0.16, the wall loading of said reduced mercury lamp being equivalent to a standard metal halide lamp of about 20 W/cm².

2. The lamp according to claim 1 wherein said metal halide comprises Na and/or Sc iodides of various ratios depending on the color temperature desired, and a rare gas selected from the group consisting of Xe, Kr, Ar in pressures of 10-300 torr dependent on the power loading and desired operating voltage of the lamp.

3. The lamp according to claim 1 further including ZnI₂ as a buffer gas to reduce heat loss and allow for higher arc temperature.

4. The lamp according to claim 1 wherein said outer jacket is filled with either nitrogen or kept under vacuum depending on the required performance.
